(19) United States
(12) Patent Application Publication
(10) Pub. No.: US 2006/0279591 A1
(43) Pub. Date: Dec. 14, 2006

(54) Inkjet printer capable of adjusting size of Ink droplet

(75) Inventor: Jae-Yoon Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/434,140

(22) Filed: May 16, 2006

(30) Foreign Application Priority Data
Jun. 10, 2005 (KR) 2005-0050055

(51) Int. Cl. B41J 29/38

(52) U.S. Cl. 347/9

(57) ABSTRACT

Provided is an inkjet printer, comprising a print head including a chamber, a heater to heat ink accommodated in the chamber, and an ejector from which the heated ink is ejected; an ink adjusting input to adjust the size of an ink droplet ejected from the print head; and a controller to control the size of the ink droplet ejected according to a signal received from the ink adjusting input. Thus, the present invention provides an inkjet printer which adjusts the density of a printed image according to a user's selection.

### CROSS-REFERENCE TO RELATED APPLICATIONS

This application claims the benefit under 35 U.S.C. § 119(a) of Korean Patent Application No. 2005-0050055, filed on Jun. 10, 2005, in the Korean Intellectual Property Office, the entire disclosure of which is hereby incorporated by reference.

### BACKGROUND OF THE INVENTION

1. Field of the Invention

The present invention relates to an inkjet printer. More particularly, the present invention relates to an inkjet printer which adjusts a size of an ejected ink droplet.

2. Description of the Related Art

Generally, a thermal-type inkjet printer comprises a print head 100 which comprises a heater 120 and a plurality of chambers 130 as shown in FIG. 1.

The print head 100 comprises a substrate 110. A heater 120 is disposed on the substrate 110 to generate heat energy. Ink chambers 130 are formed above the heater 120 on the substrate 110. An ejector 140 is formed on an upper part of the ink chamber 130.

The heater 120 is electrically connected to an electrode through a wire (not shown) and selectively receives heating voltage pulses 1 from the electrode, see FIG. 2. Then, the heater 120 is heated to generate a bubble B inside the ink chambers 130 and ejects the ink filled in the ink chambers 130 to the outside through ejector 140.

The heating voltage pulses 1 which are applied to the heater 120 to eject ink are shown in FIG. 2. As shown therein, all the heating voltage pulses 1 comprise a constant voltage level and a pulse width “ta”. The heater 120 which receives the uniformly controlled heating voltage pulses 1, consistently controls the size of an ink droplet D ejected from ink chamber 130, thereby realizing consistent print image density.

However, in a conventional inkjet printer, it is difficult to adjust the density of the printed image to be thicker or thinner as a user's demand.

Korean Patent Application No. 1999-11912 discloses “A method of adjusting printing density in an inkjet printer” which was filed on Apr. 6, 1999 by the present applicant to deal with the foregoing problem. The entire disclosure of which is hereby incorporated by reference.

Accordingly, there is a need for an improved inject printer that can adjust the density of the printed image to be thicker or thinner as a user's desires.

### SUMMARY OF THE INVENTION

An aspect of embodiments of the present invention is to address at least the above problems and/or disadvantages and to provide at least the advantages described below. Accordingly, an aspect of the present invention is to provide an inkjet printer which adjusts the density of a printed image according to a user's selection.

The foregoing and/or other aspects of exemplary embodiments of the present invention are achieved by providing an inkjet printer, comprising a print head comprising a chamber, a heater for heating ink accommodated in the chamber, and an ejector for ejecting the heated ink; an ink adjusting input for adjusting a size of an ink droplet ejected from the print head; and a controller for controlling. the size of the ink droplet ejected according to a signal received from the ink adjusting input.

According to an aspect of embodiments of the present invention, the controller applies a heating voltage pulse that is either increased or decreased in width according to the signal received from the ink adjusting input, to the heater to adjust the size of the ejected ink droplet.

According to an aspect of embodiments of thr present invention, the controller applies a heating voltage pulse that is either increased or decreased in height according to the signal received from the ink adjusting input, to the heater to adjust the size of the ejected ink droplet.

According to an aspect of embodiments of the present invention, the controller applies a heating voltage pulse that is either increased or decreased in height and either increased or decreased in width according to the signal received from the ink adjusting input, to the heater to adjust the size of the ejected ink droplet.

According to an aspect of embodiments of the present invention, the heater comprises a plurality of heater elements, and the controller selectively applies the heating voltage pulse to the heater to one or more of the plurality of heater elements according to the signal received from the ink adjusting input to adjust the size of ejected ink droplet.

According to an aspect of the present invention, the heater comprises a plurality of heater elements with at least two being a different size. According to an aspect of the present invention, the ink adjusting input comprises an adjustment switch that generates an analog signal. According to an aspect of embodiments of the present invention, the ink adjusting input comprises a selection switch and a plurality of level display lamps which are turned on by the selection switch that generates a digital signal.

Other objects, advantages, and salient features of embodiments of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a partial sectional view of a print head of a conventional inkjet printer;

FIG. 2 illustrates a heating voltage pulse waveform which is applied to a heater in FIG. 1;

FIG. 3 is a block diagram to illustrate components of an inkjet printer according to a first embodiment of the present invention;

FIGS. 4a and 4b are schematic views to illustrate embodiments of an ink adjusting input in FIG. 3;

FIG. 5 illustrates an example of a heating voltage pulse waveform which is applied to a heater in FIG. 3;

FIG. 6 is a partial sectional view of a print head of the inkjet printer according to the first embodiment of the present invention;

FIG. 7 is a graph to illustrate another example of the heating voltage pulse waveform which is applied to the heater in FIG. 3;

FIG. 8 is a plan view of a heater of an inkjet printer according to a second embodiment of the present invention;

FIG. 9 is a partial sectional view of a print heat which applies the heater thereto in FIG. 8; and

FIG. 10 is a plan view of a heater of an inkjet printer according to a third embodiment of the present invention.

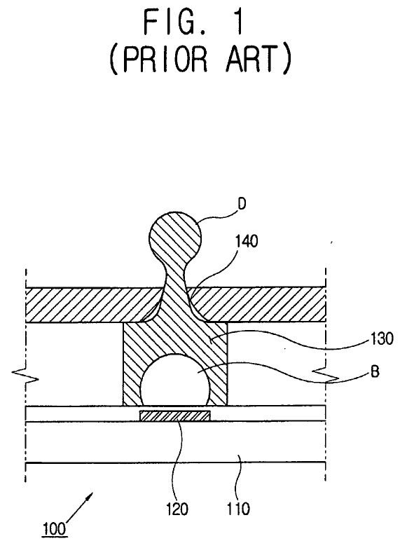

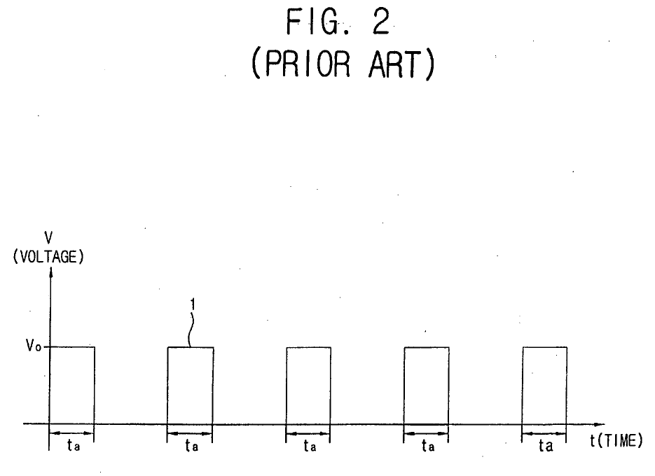

Throughout the drawings, the same drawing reference numerals will be understood to refer to the same elements, features, and structures.

### DETAILED DESCRIPTION OF THE EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

An inkjet printer according to an embodiment of the present invention comprises an image forming apparatus such as a printer, a facsimile, a photocopier, or any other image forming apparatus which utilize a thermal heater.

Since the configuration of the inkjet printer, according to the embodiments of the present invention, are the same as that in the patent application described in the prior art, a description thereof will be omitted in the present specification.

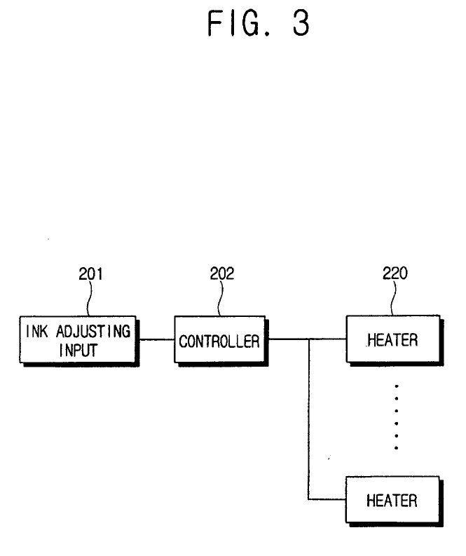

As shown in FIG. 3, an inkjet printer according to an embodiment of the present invention comprises an ink adjusting input 201 to adjust the size of an ejected ink droplet; a controller 202 to generate a heating voltage pulse according to a signal received from the ink adjusting input 201; and a heater 220 to receive the heating voltage pulse from the controller 202 and to generate heat so as to eject the ink.

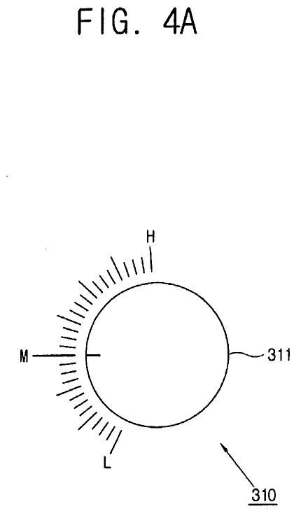

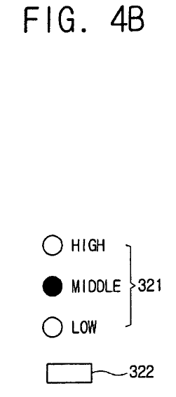

The ink adjusting input 201 generates either an analog or a digital signal. An analog-type ink adjusting input 201 may be provided as an adjustment switch 310 comprising a rotary knob 311, as shown in FIG. 4A. A digital-type ink adjusting input 201, as shown in FIG. 4B, may be a combination of a plurality of level display lamps 321 and a selection switch 322 to select the level display lamps 321. However, the ink adjusting input 201 is not limited to the foregoing examples. Alternatively, the ink adjusting input 201 may be provided as any structure that generates a variable signal.

Preferably, the ink adjusting input 201 is provided in a casing (not shown) of the inkjet printer that is easily adjustable by a user, and more particularly, is added to a control panel (not shown) which controls an operation of the inkjet printer.

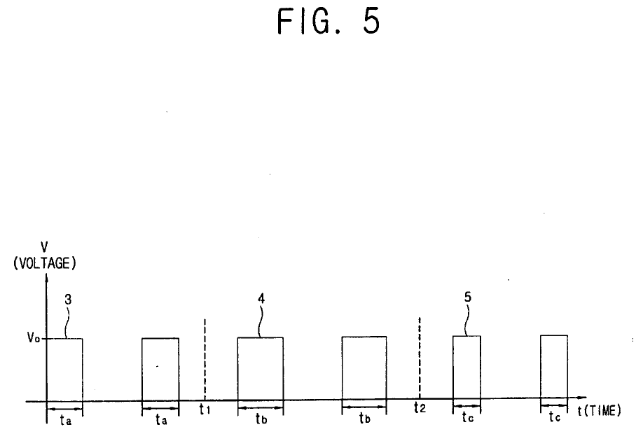

The controller 202 applies heating voltage pulses 3, 4 and 5, as shown in FIG. 5, to the heater 220 to eject ink. The configuration and function of the controller 202 will not be described since it is included in the prior art.

Also, the controller 202 receives a signal which is adjusted in the ink adjusting input 201. The controller 202, according to the received signal, increases and decreases a width of the heating voltage pulse applied to the heater 220 to adjust the size of each ink droplet ejected.

For example, if the ink adjusting input 201 is provided as the adjustment switch 310 shown in FIG. 4A, the controller 202 gradually increases the width of the heating voltage pulse as a user rotates knob 311 from a medium level “M” to a high level “H”, and gradually decreases the width of the heating voltage pulse as a user rotates the knob 311 from the medium level “M” to a low level “L”.

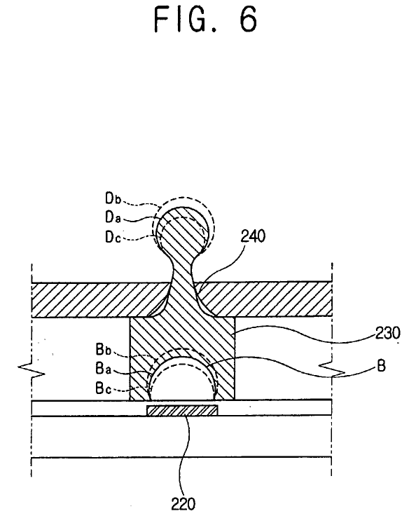

FIG. 5 illustrates waveforms of the heating voltage pulses 3, 4 and 5 corresponding to an operation of the adjustment switch 310 that is applied from the controller 202 to the heater 220. The heater 220 is disposed in a single ink chamber 230, as shown in FIG. 6. The transverse axis. refers to time “t”, and a vertical axis refers to a voltage “V” in FIG. 5.

Heating voltage pulse 3 is applied to corresponding heater 220 at the time “t₀”, and comprises a voltage of “V₀” and a pulse width Of “tₐ”.

If the knob 311 of the adjustment switch 310 rotates from the medium level “M” to the high level “H” at time “t₁”, the width of the heating voltage pulse 4 generated after time t₁ increases to “t_{b}”. If the knob 311 of the adjustment switch 310 rotates from the medium level “M” to the low level “L” at time t₂, the width of the heating voltage pulse 5 decreases to “t_{c}”. In this embodiment, the pulse height is consistently maintained as “V₀”.

FIG. 6 illustrates the ink droplet ejected from the ink chamber 230 as the controller 202 applies the heating voltage pulse to the heater 220.

As shown therein, “Bₐ” and “Dₐ” respectively refer to a bubble and an ejected ink droplet which are generated between to and t₁, representing the ink droplet ejected at a normal state. Also, “B_{b}” and “D_{b}” respectively refer to a bubble and an ejected ink droplet which are generated between t₁ and t₂, which are bigger than those at the normal state. “B_{c}” and “D_{c}” respectively refer to a bubble and an ejected ink droplet generated since t₂, which are smaller than those at the normal state.

Thus, the size of the ink droplet ejected from the ejector 240 is adjusted, thereby varying the density of the printed image formed on a printed sheet of paper.

Meanwhile, the controller 202 may vary the heating voltage applied to the heater 220 to adjust the size of the ejected ink droplet.

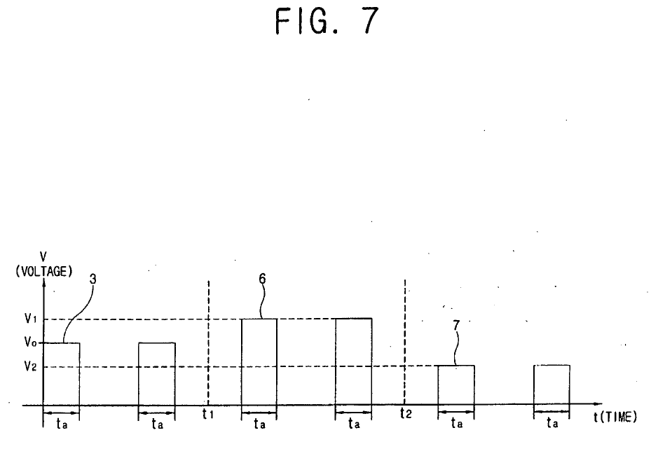

FIG. 7 illustrates waveforms of heating voltage pulses 3, 6 and 7 applied to the heater 220 when the controller 202 changes the heating voltage. The heater 220 is disposed in a single ink chamber 230. Heating voltage pulse 3 is applied to the corresponding heater 220 at time of “t₀”, and comprises a voltage of “V₀” and a pulse width of “tₐ”.

If the controller 202 applies the heating voltage pulse at a pulse height “V₁” to the heater 220 through the adjustment switch 310 at the time of “t₁”, the height of the heating voltage pulse 6 generated after time “t₁” increases to “V₁”. If the controller 202 applies the heating voltage pulse at a pulse height “V₂” to the heater 220 at time “t₂”, the pulse height of the heating voltage pulse 7 decreases to “V₂”. In this embodiment, the pulse width is consistently maintained as “tₐ”.

Accordingly, if the height of the heating voltage pulse is changed instead of the width by the controller 202, the bubble and the ejected ink droplet are the same as. those in FIG. 6. The controller 202 may also adjust the size of the ejected ink droplet by varying both the width and height of the heating voltage pulse applied to the heater 220.

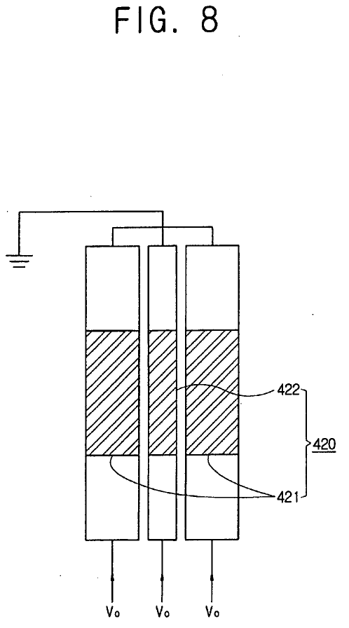

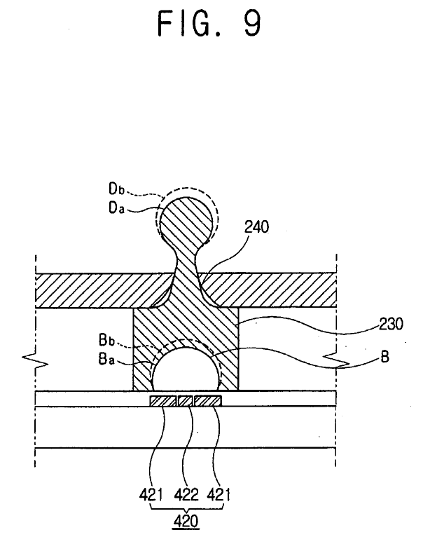

As shown in FIGS. 8 and 9, the size of the ejected ink droplet may be adjusted by a plurality of heaters 420. For example, the size of the ejected ink droplet may be adjusted by providing the heater 420 as first heaters 421 and a second heater 422 and having the controller 202 selectively apply the heating voltage pulses to the respective heaters. At this time, only the first heaters 421, disposed at opposite sides, receive the heating voltage pulse if normal image density is required. If thicker image density is required, the second heater 422 also receives the heating voltage pulse together with the first heaters 421. As shown in FIG. 9, “Bₐ” and “Dₐ” respectively refer to the bubble and the ejected ink droplet when only the first heaters 421 receive the heating voltage pulse. “B_{b}” and “D_{b}” respectively refer to the bubble and the ejected ink droplet when the second heater 422 receives the heating voltage pulse together with the first heaters 421.

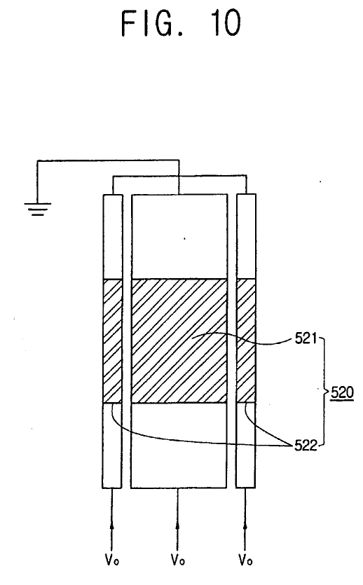

The configuration of the plurality of heaters may alternatively be provided as a first heater 521 and second heaters 522 as shown in FIG. 10, or in any other manner to adjust the size of the ejected ink droplet.

While the invention has been shown and described with reference to certain embodiments thereof, it will be understood by those skilled in the art that various changes in form and details may be made therein without departing from the spirit and scope of the invention as defined by the appended claims.

What is claimed is:

1. An inkjet printer, comprising:
a print head comprising a chamber, a heater for heating ink accommodated in the chamber, and an ejector for ejecting the heated ink;
an ink adjusting input for adjusting a size of an ink droplet ejected from the print head; and
a controller for controlling the size of the ink droplet ejected according to a signal received from the ink adjusting input.

2. The inkjet printer according to claim 1, wherein the controller applies a heating voltage pulse that is either increased or decreased in width according to the signal received from the ink adjusting input, to the heater to adjust the size of the ejected ink droplet.

3. The inkjet printer according to claim 1, wherein the controller applies a heating voltage pulse that is either increased or decreased in height according to the signal received from the ink adjusting input, to the heater to adjust the size of the ejected ink droplet.

4. The inkjet printer according to claim 1, wherein the controller applies a heating voltage pulse that is either increased or decreased in height and either increased or decreased in width according to the signal received from the ink adjusting input, to the heater to adjust the size of the ejected ink droplet.

5. The inkjet printer according to claim 1, wherein the heater comprises a plurality of heater elements, and the controller selectively applies the heating voltage pulse to one or more of the plurality of heater elements according to the signal received from the ink adjusting input to adjust the size of ejected ink droplet.

6. The inkjet printer according to claim 5, wherein the heater comprises a plurality of heater elements with at least two being a different size.

7. The inkjet printer according to claim 1, wherein the ink adjusting input comprises an adjustment switch and wherein the ink adjusting input generates an analog signal.

8. The inkjet printer according to claim 1, wherein the ink adjusting input comprises a selection switch and a plurality of level display lamps which are turned on by the selection switch and wherein the ink adjusting input generates a digital signal.
